(19) United States
(12) Patent Application Publication
(10) Pub. No.: US 2008/0071468 A1
(43) Pub. Date: Mar. 20, 2008

(54) Method for Releasing Navigation Data Stored on a Storage Medium

(76) Inventor: Thomas Lungwitz, Stuttgart (DE)

Correspondence Address: KENYON & KENYON LLP, ONE BROADWAY, NEW YORK, NY, 10004, US

(21) Appl. No.: 11/661,076

(22) PCT Filed: Jul. 21, 2005
(86) PCT No.: PCT/EP05/53559

§ 371 Date: Sep. 14, 2007

(30) Foreign Application Priority Data
Aug. 26, 2004 (DE) 10 2004 041 240.5

(51) Int. Cl. G01C 21/00

(52) U.S. Cl. 701/200

(57) ABSTRACT

A method for releasing navigation data stored in a storage medium includes the following steps: a) providing at least one list, which includes at least one, preferably a plurality of, temporary codes; b) the user inputting a temporary code into the navigation system; c) the navigation system checking the validity of the temporary code; d) the user selecting a country or a region; and e) releasing the navigation data of the country or the region for use in the navigation system for a limited period of time; which step (d) may occur prior to or after step (c).

### BACKGROUND OF THE INVENTION

1. Field of the Invention

The present invention relates to a method for releasing navigation data stored on a storage medium.

2. Background Information

Methods for granting rights to use programs and data files for navigation devices in motor vehicles are known from the related art. By purchasing a navigation system, the user normally receives map material stored on a storage medium such as a DVD or a CD, for a wide area such as all of Europe. The individual user is typically only interested in a limited section of the map material, such as only the road-map data of his native country or a neighboring country, when he never travels around in other countries with his own motor vehicle.

Published European patent document EP 1 139 196 describes a method for granting rights to use a data file, which is stored on a storage medium together with at least one additional data file and is provided with an identifier, for use by a single computer system or a limited number of local computer systems. The method is particularly suited for the application of granting rights to use road-map material in navigation systems.

To release the areas of the databases on the storage medium that are desired by the user, there are already products and designs that pursue the objective of keeping the license costs occurring for the user low and still simultaneously carrying along the complete data set for optional use. The business model C-IQ (Intelligent Content on Demand) is known from VDO-Dayton. It relates to a flexible software concept, in which the map contents can be individually selected. In order to reserve particular navigation content, the user requests a suitable access code from a dealer via the Internet or by telephone. This is entered into the navigation system and contains information regarding the desired start date and end date of the license or a particular time period from the time of activation in the system and the desired country or region whose data the user requires.

A similar example is the system concept CANDy (Conditional Access for Navigation Data and Systems) from the internal Bosch department CM-DI/ESN, in the present version 0.2 of Jan. 16, 2004; authors: Listle, Holger.

A disadvantage of the above-mentioned designs is that prior to the trip, the user must consider when he would like to consult which map material. He must make contact with an external office, whether by telephone or by Internet. In particular, when the user does not yet know, at the starting time of the trip, the number of countries or also the order of the countries through which he would like to drive, he is possibly forced to make an expensive phone call from out of the country in order to receive the correct access code from the service center.

Also known from the related art are transaction numbers (TAN), which one obtains in the form of a list as a subscriber in electronic banking. These transaction numbers are used for initiating booking events. The transaction number is regarded as an electronic signature and expires after one-time use.

### BRIEF SUMMARY OF THE INVENTION

An object of the present invention is to specify a method, which offers the user a very high degree of flexibility both prior to and during the trip with the motor vehicle.

The method of the present invention comprises the following steps:
(a) providing at least one list, which includes at least one, preferably a plurality of, temporary codes;
(b) the user inputting a temporary code into the navigation system;
(c) the navigation system checking the validity of the temporary code;
(d) the user selecting a country or a region;
(e) releasing the navigation data of the country or the region for use in the navigation system for a limited period of time;
   step (d) being able to occur prior to or after step (c).

This has the advantage that the user only has to have access to a list of temporary codes in the motor vehicle, in order to quickly obtain access to the map material of different countries. He does not have to think about the selected route of his trip prior to the start of the trip, since he can now quickly select the area whose road network should be released, even as a function of the specific traffic situation. The user is now independent from the provision of external services. This also produces cost savings for the service provider, since the service of a call center staffed around the clock does not have to be paid for.

An example refinement of the present invention provides for the list of temporary codes to be sent to the user by mail or electronically. This provides a form that is similar to the idea of transaction numbers (TAN) in banking via the Internet. The user probably has certain experience with such a design.

It is also provided that at least one list of temporary codes be available to the navigation device upon acquisition, particularly in the form of a sticker, a plastic card, or the like. By this means, the user easily becomes used to the manner of functioning of the method according to the present invention for releasing the navigation data.

In this context, it is possible for the last characters to be added onto the sticker, the plastic card, or the like by the user. In this manner, only a small number of stickers are necessary for generating a large number of temporary codes. It is further possible that a list of temporary codes be generated by the navigation system after a password, code, or the like is inputted into the navigation system. This has the advantage that the user does not have to manually input the specific temporary code, but can simply select it, for example, by clicking on a specific position on the video screen.

### BRIEF DESCRIPTION OF THE SEVERAL VIEWS OF THE DRAWING

FIG. 1 shows a flowchart of the method according to the present invention.

### DETAILED DESCRIPTION OF THE INVENTION

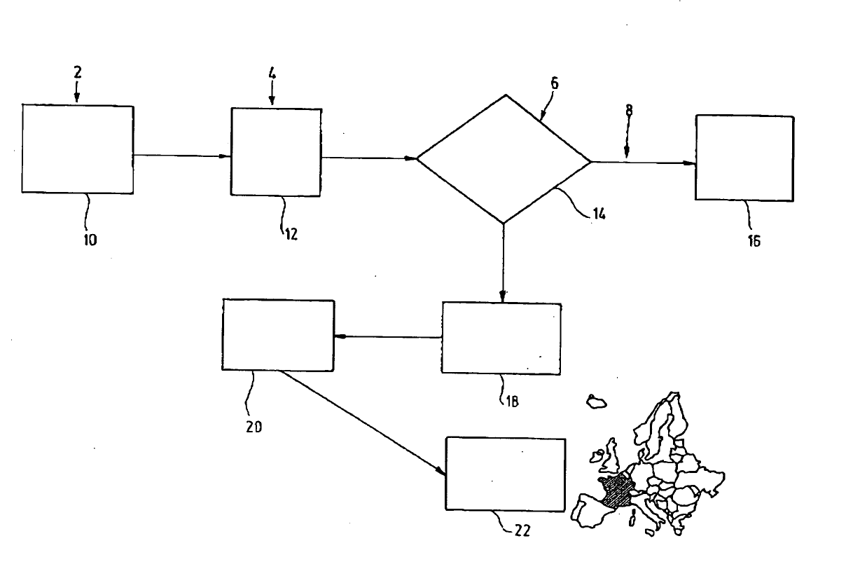

As shown in FIG. 1, an external service provider 2 generates a list of temporary codes 10. User 4 receives a list by mail in the same form as a list of TAN codes in Internet banking. He now has a specific number of licenses, which are valid for a minimum period of time (e.g., on the calendar day of activation or for 24 hours from activation), and which expire after one-time use. The user selects a temporary code from the list of 12, as required. He can do this prior to the start of the trip or also during the trip; the only prerequisite is that the user take the list with him in the vehicle. This is also particularly advantageous when the driver is not the owner of the motor vehicle and, for example, does not know the exact licensing model of the road-map data. The user can decide, in an equally spontaneous manner, which road network he would like to use as a function of the traffic situation, e.g., in the event of a traffic jam. A first list of temporary codes can already be available upon acquisition of the device, so that the user can simply get used to the new release idea. After temporary code 12 is inputted, the inputted code is checked 14 by navigation system 6. When an incorrect code is inputted 8, the procedure is aborted 16, or the user is prompted to input a code again. When the code is correct, the navigation system indicates the regions or countries, which may be released for a limited period of time 18. Suitable for this is a textual representation in the form of a list in which the user may navigate, or a graphical representation of the map in which the borders of the areas in question are marked. The user may now simply select a suitable region 20. For example, during his trip from Germany to Spain, the user may have the appropriate roadmap of France released in front of the border crossing to France. The digital roadmap is now accessible 22 for 24 hours and is blocked again after they elapse.

1-7. (canceled)

8. A method for releasing navigation data stored on a storage medium of a navigation system in a motor vehicle, comprising:
(a) providing at least one list including at least one temporary code;
(b) inputting, by a user, the at least one temporary code into the navigation system;
(c) checking, by the navigation system, the validity of the at least one temporary code inputted;
(d) if the at least one temporary code inputted is valid, enabling the user to select one of a country and a region; and
(e) releasing navigation data of the selected one of the country and the region for use in the navigation system for a limited period of time;
wherein step (d) occurs one of prior to step (c) and after step (c).

9. The method as recited in claim 8, wherein the at least one list including the at least one temporary code is sent to the user one of by mail and electronically.

10. The method as recited in claim 8, wherein the at least one list including the at least one temporary code is provided in connection with the navigation device, and wherein the at least one list is in the form of one of a sticker and a plastic card.

11. The method as recited in claim 10, further comprising:
modifying, by the user, the at least one temporary code by adding a last character.

12. The method as recited in claim 8, wherein the at least one list includes a plurality of temporary codes, and wherein the plurality of temporary codes are generated by the navigation system after a password is inputted into the navigation system.

13. The method as recited in claim 12, wherein the limited period of time for the use of a temporary code is predefined.

14. A navigation system of a motor vehicle, comprising:
a storage medium storing navigation data;
an input unit for accepting user inputs into the navigation system; and
a control unit;
wherein (a) at least one list including at least one temporary code is provided, (b) a user inputs the at least one temporary code into the navigation system, (c) the control unit checks the validity of the at least one temporary code inputted, (d) if the at least one temporary code inputted is valid, enabling the user to select one of a country and a region, and (e) releasing navigation data of the selected one of the country and the region for use in the navigation system for a limited period of time, wherein step (d) occurs one of prior to step (c) and after step (c).
